(19) United States
(12) Patent Application Publication
(10) Pub. No.: US 2017/0118072 A1
(43) Pub. Date: Apr. 27, 2017

(54) COMMUNICATION CONTROL METHOD, NETWORK SYSTEM, AND COMMUNICATION CONTROL DEVICE

(71) Applicant: FUJITSU LIMITED, Kawasaki-shi (JP)

(72) Inventor: Kenji Hikichi, Kawasaki (JP)

(73) Assignee: FUJITSU LIMITED, Kawasaki-shi (JP)

(21) Appl. No.: 15/290,411

(22) Filed: Oct. 11, 2016

(30) Foreign Application Priority Data
Oct. 26, 2015 (JP) 2015-210174

(51) Int. Cl. H04L 12/24; H04L 12/707

(52) U.S. Cl. CPC H04L 41/0672; H04L 45/22; H04L 41/0816

(57) ABSTRACT

A communication control method executed by a system including a plurality of nodes, a plurality of communication control devices, a network control device and a load control device, the method includes transmitting, by the load control device, a request instructing update of destination information to the plurality of communication control devices and the network control device; starting, by each of the plurality of communication control devices and the network control device, update of the destination information; completing the update by a communication control device in the plurality of communication control devices; receiving, by the communication control device, a control message transmitted from the network control device; extracting a target control device that controls a target node from the plurality of communication control devices stored in the destination information; and transferring the control message to the target control device when the target control device is not the communication control device.

### CROSS-REFERENCE TO RELATED APPLICATION

This application is based upon and claims the benefit of priority of the prior Japanese Patent Application No. 2015-210174, filed on Oct. 26, 2015, the entire contents of which are incorporated herein by reference.

### FIELD

The embodiments discussed herein are related to a communication control method, a network system, and a communication control device.

### BACKGROUND

Because of increase in demands for communications, the number of pieces of network equipment coupled to one network is increasing. For example, each relay device (for example, router) in a network individually controls the route of transfer of packets and therefore it is difficult to flexibly configure the routes of packets as the whole of the network.

In contrast, in a network to which techniques of the software defined networking (SDN) are applied, the control functions of the respective pieces of network equipment are aggregated into one piece of software and thus e.g. flexible route configuring is possible. For example, in the OpenFlow protocol, the route control functions of packets are separated from the relay devices of packets and are aggregated into a single device called an SDN controller (for example, refer to Japanese Laid-open Patent Publication No. 2015-39097). The SDN controller includes an open application programming interface (API). Thus, by setting route information in each relay device in accordance with an external control application, flexibly configuring routes of packets is enabled as the whole of the network.

In order to solve problems about the fault tolerance and the scalability of the performance accompanying concentration of control functions on the SDN controller, a distributed SDN controller has been researched and developed (for example, refer to Hikichi et al., “Study on Scalability for Distributed SDN controller,” the Institute of Electronics, Information and Communication Engineers NV workshop, 2015). The distributed SDN controller is in charge of control of not all relay devices in the network but part of the relay devices. Thus, the load of control processing of the relay devices can be distributed among plural distributed SDN controllers (hereinafter, represented as the “controller”).

A control application transmits a control message addressed to the relay device only to the controller that controls this relay device. Because of restrictions on the specifications of the OpenFlow network, the controller can transmit the control message only to the relay device that is controlled by the controller and does not transmit the control message to the relay device that is controlled by other controller.

For this reason, it is preferable that, between the control application and the controllers, pieces of information indicating the correspondence relationship between the controller and the relay devices controlled by this controller (hereinafter, “controller information”) correspond with each other. The controller information is dynamically changed even in operation for executing load balancing processing or failover processing. As management systems of the controller information, a centralized management system in which a specific information management server manages the controller information and a cache system in which the control application and the controllers are made to hold the controller information as a cache (for example, refer to Pankaj Berde et al., “ONOS: Towards an Open, Distributed SDN OS,” HotSDN′ 14, Aug. 22, 2014) are cited.

In the case of the centralized management system, the control application and the controllers refer to the controller information in the common information management server. For this reason, discordance of the controller information does not occur between the control application and the controllers. However, access from the control application and plural controllers concentrates on the information management server and the load of the information management server increases. Therefore, improvement in the performance such as the processing speed is difficult in the centralized management system.

On the other hand, in the case of the cache system, the control application and the controllers each update the cache of the controller information held in the self-device in accordance with an update instruction transmitted from a device of the update source of the controller information. For this reason, in the case of the cache system, the problem about the performance like that in the centralized management system does not occur.

However, the update timing of the cache of the control application and the update timing of the cache of the controllers fluctuate depending on the load of the network or the load of the device that operates the control application and the controllers themselves. Therefore, possibly the update timing of the cache varies between the control application and the controllers and discordance of the controller information occurs as a result.

If discordance of the controller information occurs between the control application and the controllers, a control message addressed to a relay device that is not a control target for the controller is transmitted from the control application to this controller. At this time, the controller does not transmit but discard the control message and makes an error notification to the control application.

When receiving the error notification, the control application retransmits the control message. Therefore, after the pieces of controller information in the control application and the controller correspond with each other due to update of the cache, the control message is transmitted from the correct controller to the relay device. However, a problem that delay is caused in control processing of the relay device due to the retransmission of the control message occurs. In view of the above-described problems, it is preferable that the delay time of the control can be reduced.

### SUMMARY

According to an aspect of the embodiments, a communication control method executed by a system, the communication control method includes transmitting, by a load control device, a request instructing update of destination information to a plurality of communication control devices that control a plurality of nodes and a network control device that controls the plurality of communication control devices, the destination information being stored in each of the plurality of communication control devices and the network control device and including a correspondence relationship between a node and a communication control device that control the node for each of the plurality of nodes; starting, by each of the plurality of communication control devices and the network control device, update of the destination information in response to the request; completing the update by a communication control device among the plurality of communication control devices; receiving, by the communication control device, a control message that is transmitted from the network control device and is for controlling a target node in the plurality of nodes; extracting a target control device that controls the target node from the plurality of communication control devices stored in the destination information of the communication control device in response to the control message; and transferring the control message from the communication control device to the target control device when it is determined that the extracted target control device is not the communication control device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a configuration diagram illustrating one example of a network system;

FIG. 2 is a diagram illustrating an operation of a comparative example of the network system;

FIG. 3 is a diagram illustrating an operation of a first embodiment of a network system;

FIG. 4 is a sequence diagram illustrating an operation of the first embodiment of the network system;

FIG. 5 is a configuration diagram illustrating one example of a load control server;

FIG. 6 is a configuration diagram illustrating one example of a network control server;

FIG. 7 is a configuration diagram illustrating one example of a controller;

FIG. 8 is a diagram illustrating an operation of ping-pong transmission of a control message in the first embodiment;

FIG. 9 is a sequence diagram illustrating an operation of a ping-pong transmission of a control message in the first embodiment;

FIG. 10 is a diagram illustrating an operation of a second embodiment of a network system;

FIG. 11 is a sequence diagram illustrating an operation of the second embodiment of the network system;

FIG. 12 is a configuration diagram illustrating another example of the controller;

FIG. 13 is a flowchart illustrating an operation of a controller in the second embodiment;

FIG. 14 is a diagram illustrating an operation of a third embodiment of a network system;

FIG. 15 is a sequence diagram illustrating an operation of the third embodiment of the network system; and

FIG. 16 is a flowchart illustrating an operation of a controller in the third embodiment.

### DESCRIPTION OF EMBODIMENTS

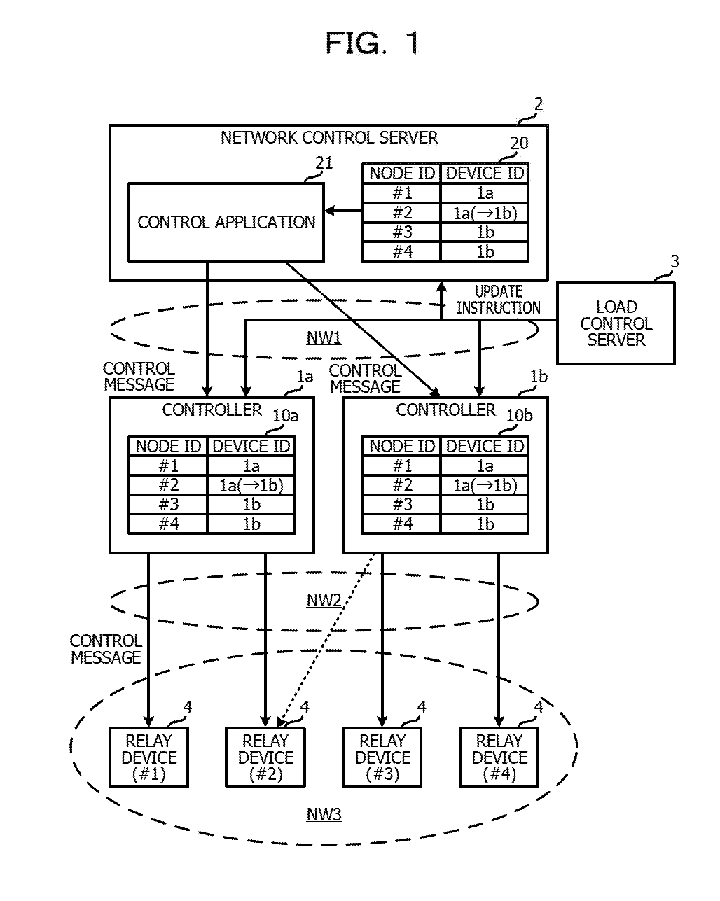

FIG. 1 is a configuration diagram illustrating one example of a network system. The network system includes controllers 1a and 1b that are one example of a communication control device, a network control server 2 that is one example of a network control device, a load control server 3 that is one example of an update device, and relay devices 4 disposed at plural nodes #1 to #4. In the present embodiment, the numbers of nodes of the controllers 1a and 1b and the relay devices 4 are one example and are not limited.

The controllers 1a and 1b, the network control server 2, and the load control server 3 carry out communications via a network NW1 for control, such as a local area network (LAN). The controllers 1a and 1b and the relay devices 4 at the respective nodes #1 to #4 carry out communications via a network NW2 for control, such as an LAN.

The relay devices 4 are disposed at the nodes #1 to #4 (see numbers in parentheses) in a network NW3 to which packets are transmitted. The relay device 4 is a switch device such as a router for example and relays packets to another communication device. As the packet, the internet protocol (IP) packet is cited for example. However, the packet is not limited thereto.

The controllers 1a and 1b are computers that control the relay devices 4 at the nodes #1 to #4. The controllers 1a and 1b each share the control of the relay devices 4 at the nodes #1 to #4. Thus, the load of control processing of the relay devices 4 at the nodes #1 to #4 is distributed to the controllers 1a and 1b.

The controllers 1a and 1b and the network control server 2 hold, as a cache, pieces of controller information 10a, 10b, and 20, respectively, indicating the correspondence relationship between the controllers 1a and 1b and the nodes #1 to #4 of the relay devices 4 controlled by the controllers 1a and 1b. That is, the pieces of controller information 10a, 10b, and 20 indicate the correspondence relationship between the respective nodes #1 to #4 and the controllers 1a and 1b that control the respective nodes #1 to #4. The pieces of controller information 10a and 10b are one example of first information and fourth information. The controller information 20 is one example of second information and third information.

In the pieces of controller information 10a, 10b, and 20, node identifications (IDs) (#1 to #4) and device IDs (represented by symbols 1a and 1b as one example) for identification of the controllers 1a and 1b are associated with each other and registered. This allows the controllers 1a and 1b and the network control server 2 to discriminate the relay devices 4 of control target nodes of the controllers 1a and 1b by referring to a respective one of the pieces of controller information 10a, 10b, and 20.

The load control server 3 instructs the controllers 1a and 1b and the network control server 2 to update the pieces of controller information 10a, 10b, and 20 (see “update instruction”). The controllers 1a and 1b and the network control server 2 update the pieces of controller information 10a, 10b, and 20 in accordance with the update instruction of the load control server 3.

In the example of FIG. 1, in the pieces of controller information 10a, 10b, and 20, the device ID corresponding to the node #2 is updated from “1a” to “1b” (see “1a (->1b)”). Due to this, the controller 1a excludes the relay device 4 of the node #2 from the control target nodes and the controller 1b adds the relay device 4 of the node #2 to the control target nodes (see dotted-line arrow).

The load control server 3 dynamically updates the pieces of controller information 10a, 10b, and 20 in operation for executing distributed processing or failover processing between the controllers 1a and 1b. The controllers 1a and 1b and the network control server 2 update the caches of the pieces of controller information 10a, 10b, and 20 in accordance with the update instruction of the load control server 3. According to this cache system, the lowering of the performance of control processing of the relay device 4 due to concentration of access does not occur differently from the centralized management system, in which a specific information management server manages the controller information.

In the network control server 2, a control application 21 based on e.g. the OpenFlow API is implemented. The control application 21 generates a control message for controlling the relay device 4. The control message is one example of control information. The control message is in conformity to the OpenFlow standards for example, and destination information, setting information of the packet relay route of the relay device 4, and so forth are included.

The control application 21 refers to the controller information 20 and retrieves the device ID corresponding to the node ID of the control target node. The control application 21 transmits a control message only to the controller 1a or 1b of the retrieved device ID. For example, the control application 21 transmits a control message addressed to the relay device 4 of the node #1 only to the controller 1a of the device ID “1a” corresponding to the node #1.

When receiving the control message from the network control server 2, the controller 1a or 1b detects the device ID corresponding to the node ID equivalent to the destination of the control message. If the detected device ID corresponds with the device ID of the self-device, the controller 1a or 1b transfers the control message to the relay device 4 of the destination. For example, if the controller 1a receives a control message addressed to the relay device 4 of the node #1, the controller 1a transfers the control message to the relay device 4 of the node #1 because the device ID corresponding to the node ID “#1” is “1a,” i.e. the device ID of the self-device.

However, if the detected device ID does not correspond with the device ID of the self-device, the controller 1a or 1b does not transfer the control message to the relay device 4 of the destination. For this reason, if discordance of the pieces of controller information 10a, 10b, and 20 exists among the control application 21 and the controllers 1a and 1b, the control message is not transmitted to the relay device 4 of the control target node #1 to #4.

As described above, the pieces of controller information 10a, 10b, and 20 are updated in accordance with the update instruction of the load control server 3. However, the update timing of the pieces of controller information 10a, 10b, and 20 fluctuates depending on the load state of the network NW1 or the load state of the network control server 2 and the controllers 1a and 1b themselves. Therefore, possibly the update timing of the pieces of controller information 10a, 10b, and 20 varies and discordance of the pieces of controller information 10a, 10b, and 20 occurs as a result. Operation in this case will be described below by taking an example.

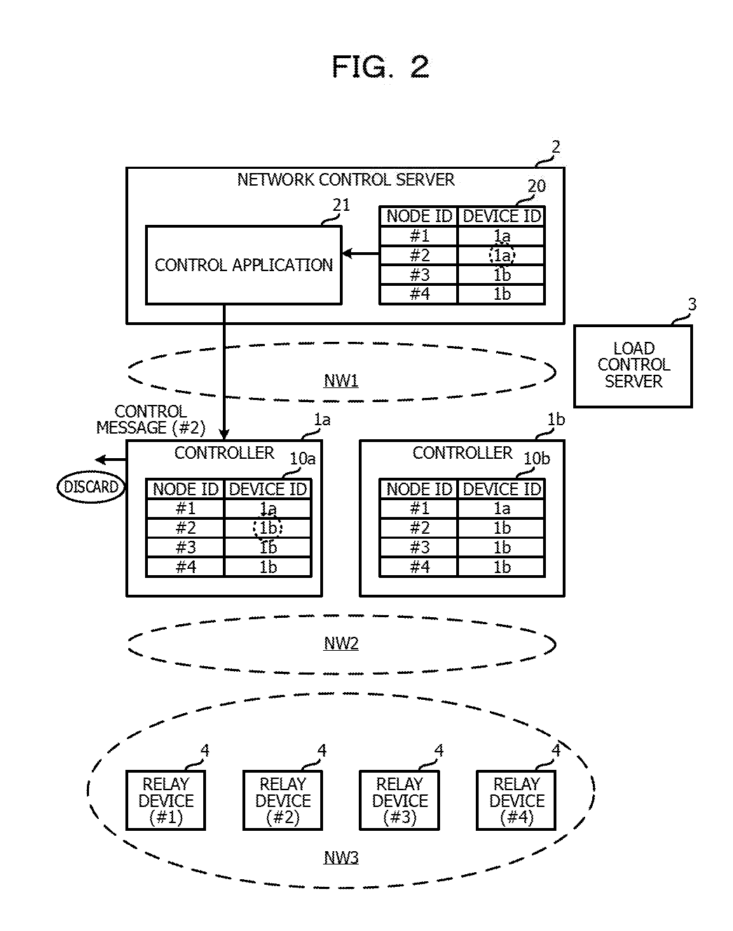

In FIG. 2, an operation of a comparative example of the network system is illustrated. In FIG. 2, a configuration common to FIG. 1 is given the same symbol and description thereof is omitted.

The present example represents the case in which update of the controller information 20 of the network control server 2 gets delayed with respect to the update instruction of the load control server 3 in the example of FIG. 1. For example, in the pieces of controller information 10a and 10b of the controllers 1a and 1b, the device ID corresponding to the node ID “#2” has been updated to “1b.” In contrast, in the controller information 20 of the network control server 2, the device ID corresponding to the node ID “#2” remains “1a.”

The control application 21 generates a control message addressed to the relay device 4 of the node #2. In the controller information 20, the node #2 is associated with the device ID “1a” (see dotted-line circle). Thus, the control application 21 transmits the control message to the controller 1a.

When receiving the control message, the controller 1a detects, from the controller information 10a held in the self-device, the device ID “1b” corresponding to the node ID “#2” equivalent to the destination of the control message (see dotted-line circle). Because the device ID “1b” does not correspond with the device ID “1a” of the self-device, the controller 1a discards the control message (see “discard”).

If a difference is generated between the controller information 20 of the control application 21 and the controller information 10a of the controller 1a as above, the control message is not transmitted to the relay device 4 of the destination. In this case, the control application 21 retransmits the control message in response to an error notification from the controller 1a. Therefore, after the pieces of controller information 20 and 10a of the control application 21 and the controller 1a correspond with each other due to update of the controller information 20, the control message is transmitted from the correct controller 1b to the relay device 4. However, delay is caused in control processing of the relay device 4 due to the retransmission of the control message.

Therefore, in the embodiment, if determining that the device that controls the control target node #2 is not the self-device based on the controller information 10a, the controller 1a transfers the control message to the other controller 1b, which controls the control target node #2, to reduce the delay time of the control. The operation of the embodiment will be described below by taking an example.

### First Embodiment

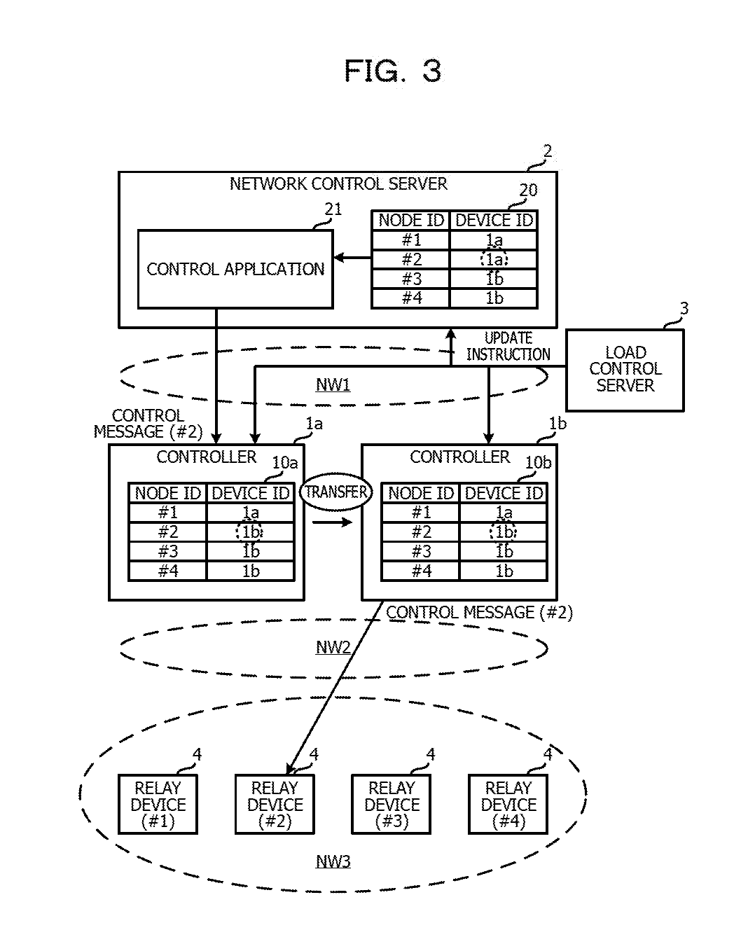

In FIG. 3, an operation of a first embodiment of a network system is illustrated. In FIG. 3, a configuration common to FIG. 1 is given the same symbol and description thereof is omitted. The contents of the pieces of controller information 20, 10a, and 10b in the present example are common to the example of FIG. 2.

The control application 21 transmits a control message addressed to the relay device 4 of the control target node #2 to the controller 1a corresponding to this relay device 4. When receiving the control message, the controller 1a detects the device ID “1b” corresponding to the node #2 as the destination of the control message (see dotted-line circle). For the controller 1a, the detected device ID “1b” does not correspond with the device ID “1a” of the self-device. Thus, the controller 1a determines that the device that controls the relay device 4 of the node #2 is not the self-device, and transfers the control message to the other controller 1b (see “transfer”).

When receiving the control message, the controller 1b detects the device ID “1b” corresponding to the node #2 as the destination of the control message (see dotted-line circle). For the controller 1b, the detected device ID “1b” corresponds with the device ID “1b” of the self-device. Thus, the controller 1b determines that the device that controls the relay device 4 of the node #2 is the self-device, and transfers the control message to the relay device 4 of the node #2.

As above, when the controller 1b associated with the control target node #2 in the controller information 10a of the self-device is not the self-device, the controller 1a transfers the control message to the other controller 1b associated with the control target node #2. Thus, the control message is not discarded and therefore the network control server 2 does not need to retransmit the control message. Accordingly, the delay time of the control of the relay device 4 of the control target node #2 is reduced.

As described with reference to FIG. 1, if the device ID corresponding to the node ID equivalent to the destination of a control message corresponds with the device ID of the self-device in the controller information 10a or 10b, the controller 1a or 1b transfers the control message to the relay device 4 of this node ID. That is, if the controller 1a or 1b associated with the control target node #1 to #4 in the controller information 10a or 10b of the self-device is the self-device, the controller 1a or 1b transfers the control message to the control target node #1 to #4. Thus, the controller 1a or 1b can control the relay device 4 of the control target node #1 to #4.

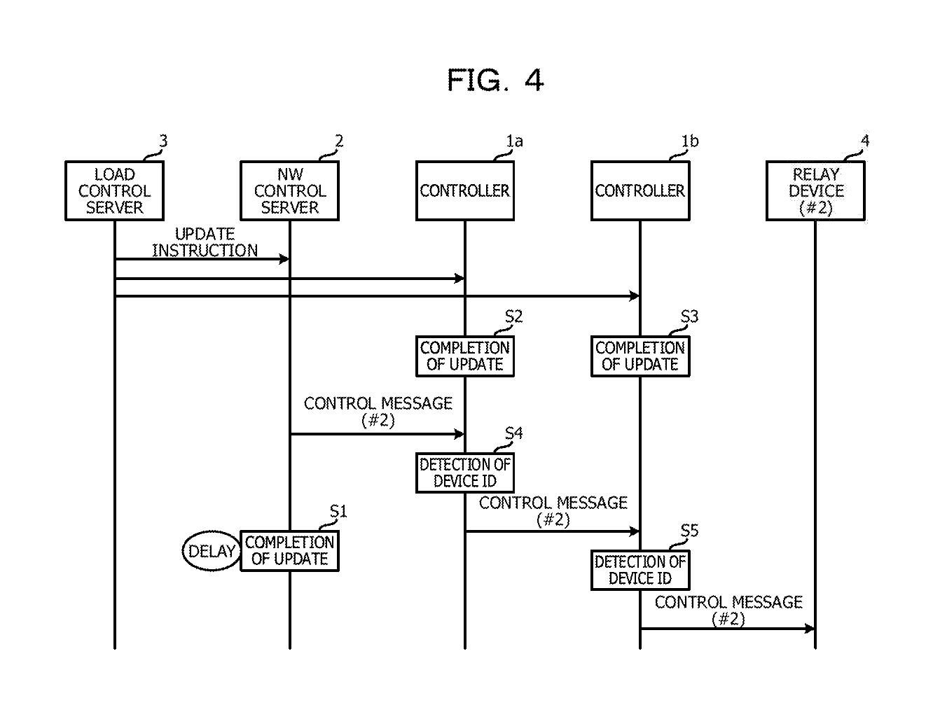

FIG. 4 is a sequence diagram illustrating an operation of the first embodiment of the network system. For example, FIG. 4 illustrates a sequence of the operation of FIG. 3.

First, the load control server 3 transmits an update instruction to the network (NW) control server 2 and the controllers 1a and 1b. The controllers 1a and 1b complete the update of the pieces of controller information 10a and 10b in accordance with the update instruction before the network control server 2 transmits a control message (see symbols S2 and S3). However, in the network control server 2, the update of the controller information 20 gets delayed (see “delay”) and is completed after the transmission of the control message (see symbol S1).

Next, the network control server 2 transmits the control message addressed to the relay device 4 of the control target node #2 to the controller 1a. The controller 1a detects the device ID “1b” corresponding to the node #2 as the destination of the control message (see symbol S4). For the controller 1a, the detected device ID “1b” does not correspond with the device ID “1a” of the self-device. Thus, the controller 1a determines that the device that controls the relay device 4 of the node #2 is not the self-device, and transfers the control message to the other controller 1b.

When receiving the control message, the controller 1b detects the device ID “1b” corresponding to the node #2 as the destination of the control message (see symbol S5). For the controller 1b, the detected device ID “1b” corresponds with the device ID “1b” of the self-device. Thus, the controller 1b determines that the device that controls the relay device 4 of the node #2 is the self-device, and transfers the control message to the relay device 4 of the node #2. In this manner, the network system operates.

Next, configurations of a controller, a network control server, and a load control server will be described.

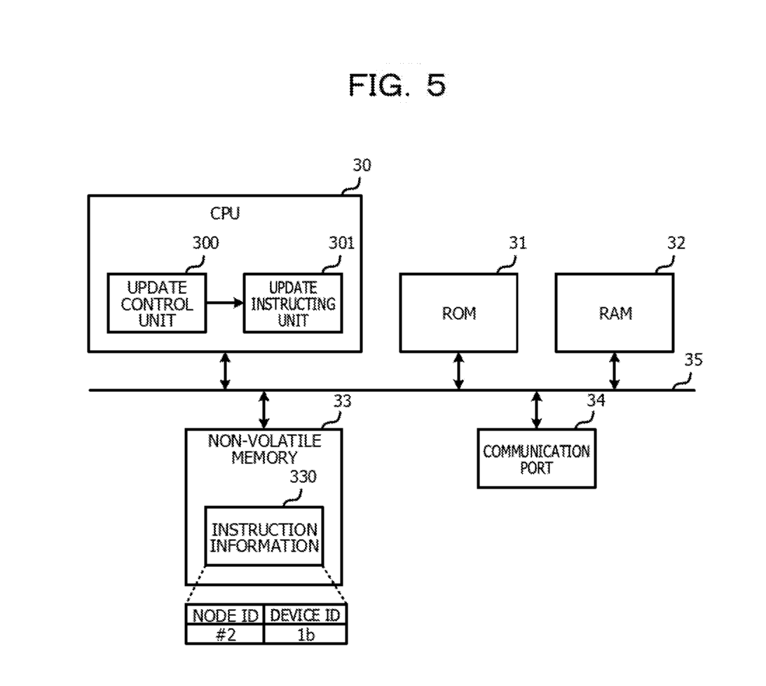

FIG. 5 is a configuration diagram illustrating one example of a load control server. The load control server depicted in FIG. 5 may be the load control server 3 depicted in FIG. 1. The load control server 3 includes a central processing unit (CPU) 30, a read only memory (ROM) 31, a random access memory (RAM) 32, a non-volatile memory 33, and a communication port 34. The CPU 30 is coupled to the ROM 31, the RAM 32, the non-volatile memory 33, and the communication port 34 via a databus 35 so that signals can be input and output mutually.

A program to drive the CPU 30 is stored in the ROM 31. The RAM 32 functions as a working memory of the CPU 30. The communication port 34 is a physical layer/media access control (PHY/MAC) device for example. The communication port 34 carries out communications with the controllers 1a and 1b and the network control server 2 via the network NW1.

Instruction information 330 included in an update instruction is held in the non-volatile memory 33. In the instruction information 330, the node ID and the device ID as the update target in the pieces of controller information 10a, 10b, and 20 are included. In the case of the update instruction in FIG. 1, the node ID “#2” and the device ID “1b” are included in the instruction information 330.

When the CPU 30 reads the program from the ROM 31, an update control unit 300 and an update instructing unit 301 are formed as functions in the CPU 30. For example, the update control unit 300 generates the instruction information 330 according to the load state of the controllers 1a and 1b and writes the instruction information 330 to the non-volatile memory 33, and notifies the update instructing unit 301 of that effect.

The update instructing unit 301 is one example of an instructing unit and instructs the network control server 2 and the controllers 1a and 1b to update the pieces of controller information 10a, 10b, and 20, respectively. For example, the update instructing unit 301 reads out the instruction information 330 from the non-volatile memory 33 in response to the notification from the update control unit 300. Then, the update instructing unit 301 transmits the update instruction including the instruction information 330 to the network control server 2 and the controllers 1a and 1b via the communication port 34.

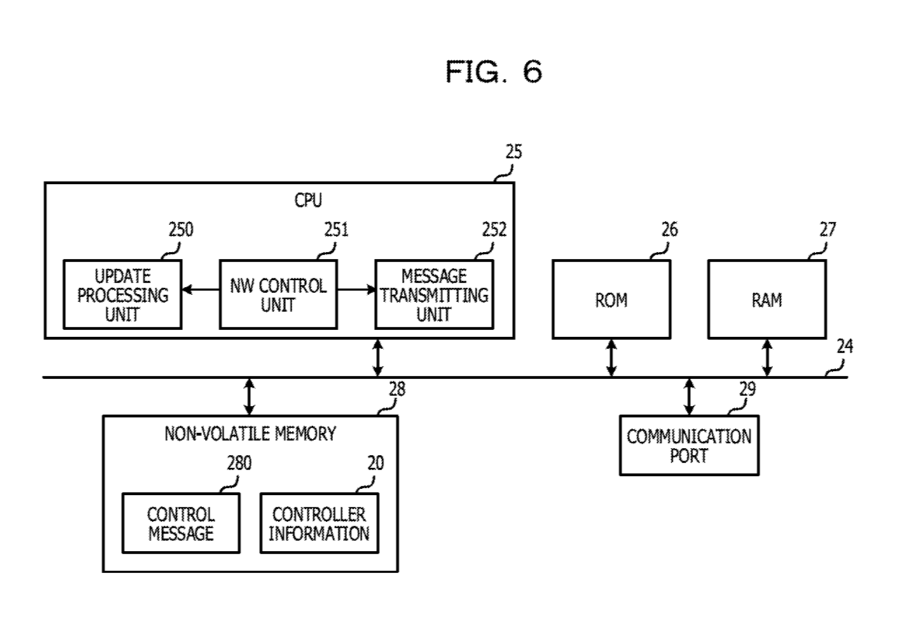

FIG. 6 is a configuration diagram illustrating one example of a network control server. The network control server depicted in FIG. 6 may be the network control server 2 depicted in FIG. 1. The network control server 2 includes a CPU 25, a ROM 26, a RAM 27, a non-volatile memory 28, and a communication port 29. The CPU 25 is coupled to the ROM 26, the RAM 27, the non-volatile memory 28, and the communication port 29 via a databus 24 so that signals can be input and output mutually.

A program to drive the CPU 25 is stored in the ROM 26. The RAM 27 functions as a working memory of the CPU 25. The communication port 29 is a PHY/MAC device for example. The communication port 29 carries out communications with the controllers 1a and 1b and the load control server 3 via the network NW1.

In the non-volatile memory 28, a control message 280 waiting for being transmitted and the controller information 20 are held. The controller information 20 indicates the correspondence relationship between the nodes #1 to #4 and the controllers 1a and 1b that control the nodes #1 to #4 as described above. The non-volatile memory 28 is one example of a first storing unit that stores the controller information 20.

When the CPU 25 reads the program from the ROM 26, an update processing unit 250, a network (NW) control unit 251, and a message transmitting unit 252 are formed as functions in the CPU 25. The network (NW) control unit 251 and the message transmitting unit 252 are equivalent to the control application 21 in FIG. 1.

The update processing unit 250 is one example of a first update processing unit and updates the controller information 20 in accordance with the update instruction of the update instructing unit 301 of the load control server 3. For example, when receiving the update instruction from the load control server 3 via the communication port 29, the update processing unit 250 updates the controller information 20 based on the instruction information 330 in the update instruction.

The network control unit 251 generates the control message 280 of a control target node and writes the control message 280 to the non-volatile memory 28. In accordance with transmission timing, the network control unit 251 reads out the control message 280 from the non-volatile memory 28 and outputs the control message 280 to the message transmitting unit 252.

The message transmitting unit 252 is one example of a transmitting unit and transmits the control message 280 to the controller 1a or 1b that controls the control target node based on information on the device ID corresponding to the control target node in the controller information 20. That is, the message transmitting unit 252 transmits the control message 280 to the controller 1a or 1b associated with the control target node in the controller information 20. The control message 280 is transmitted to the controller 1a or 1b via the communication port 29. The control message 280 thereby reaches the controller 1a or 1b that controls the control target node #1 to #4.

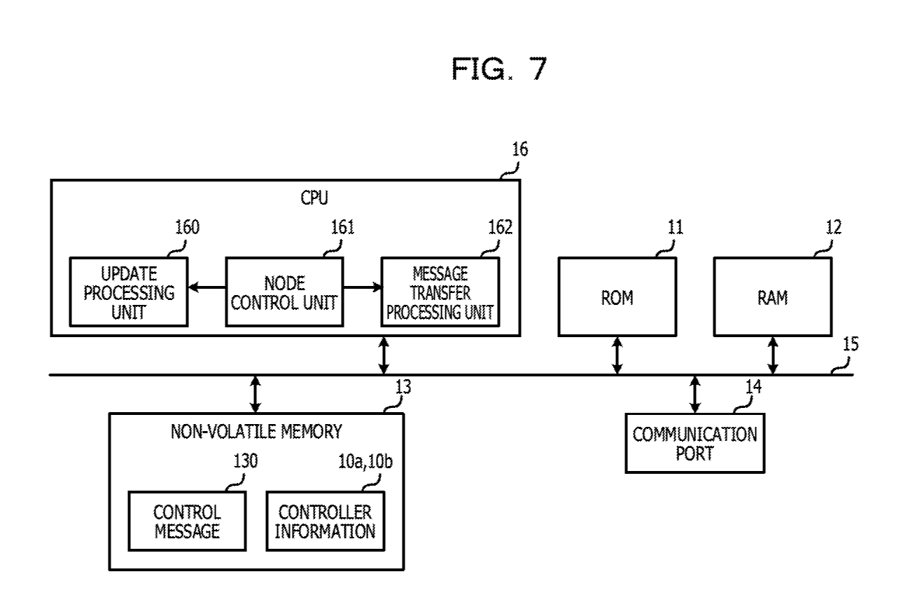

FIG. 7 is a configuration diagram illustrating one example of a controller. The controller depicted in FIG. 7 may be the controller 1a or 1b depicted in FIG. 1. The controllers 1a and 1b include a CPU 16, a ROM 11, a RAM 12, a non-volatile memory 13, and a communication port 14. The CPU 16 is coupled to the ROM 11, the RAM 12, the non-volatile memory 13, and the communication port 14 via a data bus 15 so that signals can be input and output mutually.

A program to drive the CPU 16 is stored in the ROM 11. The RAM 12 functions as a working memory of the CPU 16. The communication port 14 is a PHY/MAC device for example. The communication port 14 carries out communications with the network control server 2 and the load control server 3 via the network NW1 and carries out communications with the relay devices 4 of the respective nodes #1 to #4 via the network NW2.

In the non-volatile memory 13, a control message 130 received from the network control server 2 or the other controller 1a or 1b and the controller information 10a or 10b are held. The pieces of controller information 10a and 10b are one example of the first information and the fourth information and indicate the correspondence relationship between the nodes #1 to #4 and the controllers 1a and 1b that control the nodes #1 to #4 as described above. The non-volatile memory 13 is one example of a second storing unit that stores the controller information 10a or 10b.

When the CPU 16 reads the program from the ROM 11, an update processing unit 160, a node control unit 161, and a message transfer processing unit 162 are formed as functions in the CPU 16. The update processing unit 160 is one example of a second update processing unit. The update processing unit 160 updates the controllers 1a and 1b for each of the nodes #1 to #4 in accordance with an update instruction from the load control server 3.

The node control unit 161 is one example of a receiving unit and receives the control message 130 transmitted from the message transmitting unit 252 of the network control server 2 and writes the control message 130 to the non-volatile memory 13. After executing given processing relating to the control message 130, the node control unit 161 notifies the message transfer processing unit 162 of the completion of the processing.

The message transfer processing unit 162 is one example of a transfer processing unit. When the controller 1a or 1b associated with the control target node #1 to #4 in the controller information 10a or 10b is not the self-device, the message transfer processing unit 162 transfers the control message to the other controller 1a or 1b associated with the control target node #1 to #4. For example, when receiving the above-described notification from the node control unit 161, the message transfer processing unit 162 reads out the control message 130 and detects the device ID of the control target node equivalent to the destination of the control message 130 from the controller information 10a or 10b.

If the detected device ID is not the ID of the self-device, the message transfer processing unit 162 transfers the control message to the other controller 1a or 1b that controls the control target node #1 to #4 in accordance with the controller information 10a or 10b. Thus, the control message is not discarded and therefore the network control server 2 does not need to retransmit the control message. Accordingly, the delay time of the control of the relay device 4 of the control target node #1 to #4 is reduced.

When the controller 1a or 1b associated with the control target node #1 to #4 in the controller information 10a or 10b is the self-device, the message transfer processing unit 162 transfers the control message to the relay device 4 of the control target node #1 to #4. For example, if the detected device ID is the ID of the self-device, the message transfer processing unit 162 transfers the control message to the other controller 1a or 1b that controls the control target node #1 to #4 in accordance with the controller information 10a or 10b. This allows the controller 1a or 1b to control the relay device 4 of the control target node #1 to #4.

In the present embodiment, if discordance occurs in the pieces of controller information 10a and 10b, a phenomenon in which the control message 130 is repeatedly transmitted and received between the controllers 1a and 1b (so-called ping-pong transmission) occurs as described below.

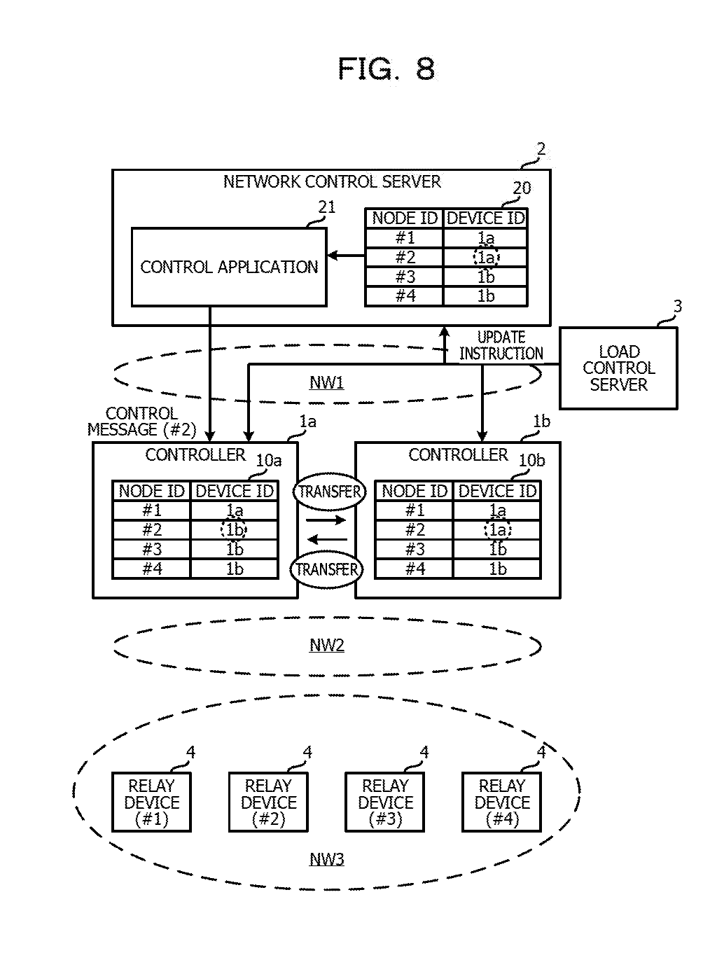

In FIG. 8, an operation of a ping-pong transmission of a control message in the first embodiment is illustrated. In FIG. 8, a configuration common to FIG. 1 is given the same symbol and description thereof is omitted.

The present example represents the case in which update of the pieces of controller information 20 and 10b of the network control server 2 and the controller 1b gets delayed with respect to the update instruction of the load control server 3 in the example of FIG. 1. That is, in the controller information 10a of the controller 1a, the device ID corresponding to the node ID “#2” has been updated to “1b.” However, in the controller information 20 of the network control server 2 and the controller information 10b of the controller 1b, the device ID corresponding to the node ID “#2” remains “1a.”

The control application 21 generates a control message addressed to the relay device 4 of the node #2. In the controller information 20, the node #2 is associated with the device ID “1a” (see dotted-line circle). Thus, the control application 21 transmits the control message to the controller 1a.

When receiving the control message, the controller 1a detects the device ID “1b” corresponding to the node #2 as the destination of the control message (see dotted-line circle). For the controller 1a, the detected device ID “1b” does not correspond with the device ID “1a” of the self-device. Thus, the controller 1a determines that the device that controls the relay device 4 of the node #2 is not the self-device, and transfers the control message to the other controller 1b (see “transfer”).

When receiving the control message, the controller 1b detects the device ID “1a” corresponding to the node #2 as the destination of the control message (see dotted-line circle). For the controller 1b, the detected device ID “1a” does not correspond with the device ID “1b” of the self-device. Thus, the controller 1b determines that the device that controls the relay device 4 of the node #2 is not the self-device, and transfers the control message to the controller 1a as the transmission source of the control message (see “transfer”).

The controllers 1a and 1b repeat the transmission and reception operation of the control message until the controller information 10b of the controller 1b is updated. That is, the controllers 1a and 1b carry out the ping-pong transmission until the completion of the update of the controller information 10b.

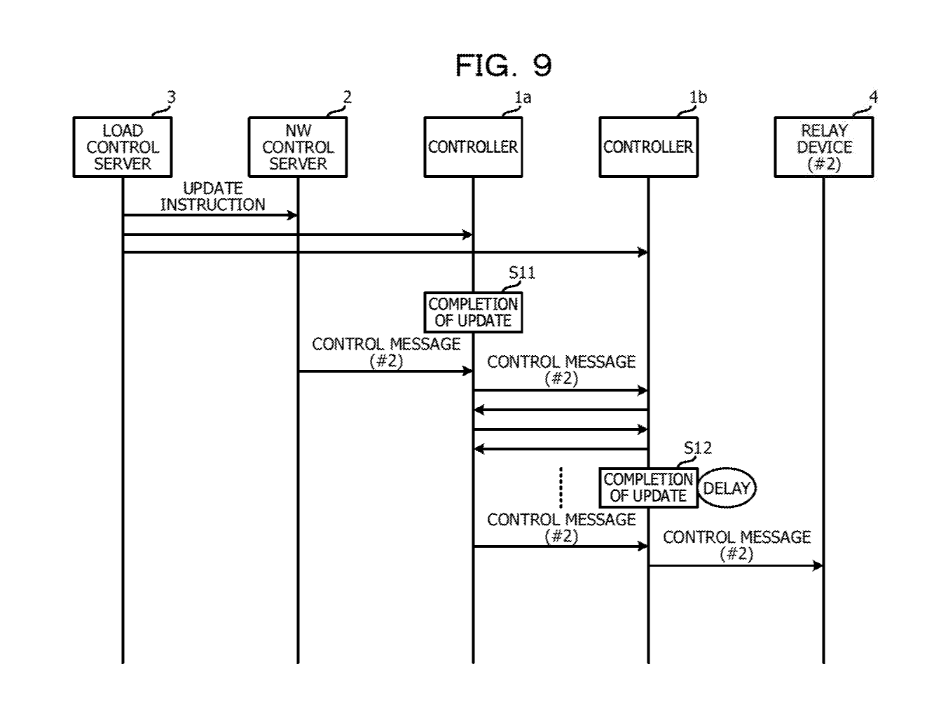

FIG. 9 is a sequence diagram illustrating an operation of a ping-pong transmission of a control message in the first embodiment. For example, FIG. 9 illustrates a sequence of the operation of FIG. 8.

First, the load control server 3 transmits an update instruction to the network control server 2 and the controllers 1a and 1b. The controller 1a completes the update of the controller information 10a in accordance with the update instruction before the network control server 2 transmits a control message (see symbol S11). On the other hand, in the network control server 2 and the controller 1b, the update of the pieces of controller information 20 and 10b gets delayed (see “delay”) and is completed after the transmission of the control message (see symbol S12).

Next, the network control server 2 transmits the control message addressed to the relay device 4 of the control target node #2 to the controller 1a. For the controller 1a, the device ID “1b” corresponding to the node #2 as the destination of the control message does not correspond with the device ID “1a” of the self-device. Thus, the controller 1a determines that the device that controls the relay device 4 of the node #2 is not the self-device, and transfers the control message to the other controller 1b.

For the controller 1b, the device ID “1a” corresponding to the node #2 as the destination of the control message does not correspond with the device ID “1b” of the self-device. Thus, the controller 1b determines that the device that controls the relay device 4 of the node #2 is not the self-device, and transfers the control message to the other controller 1a. This causes the control message to be subjected to ping-pong transmission between the controllers 1a and 1b.

In the controller 1b, after the completion of the update of the controller information 10b (see symbol S12), the device ID “1b” corresponding to the node #2 as the destination of the control message corresponds with the device ID “1b” of the self-device. Thus, the controller 1b determines that the device that controls the relay device 4 of the node #2 is the self-device. Therefore, the controller 1b transfers the control message to the relay device 4 of the node #2, so that the ping-pong transmission stops.

In order to avoid the above-described ping-pong transmission of the control message, when transmitting the control message, the network control server 2 and the controller 1a may give comparison information for comparing the newness between the pieces of controller information 20 and 10a to the control message as described below.

### Second Embodiment

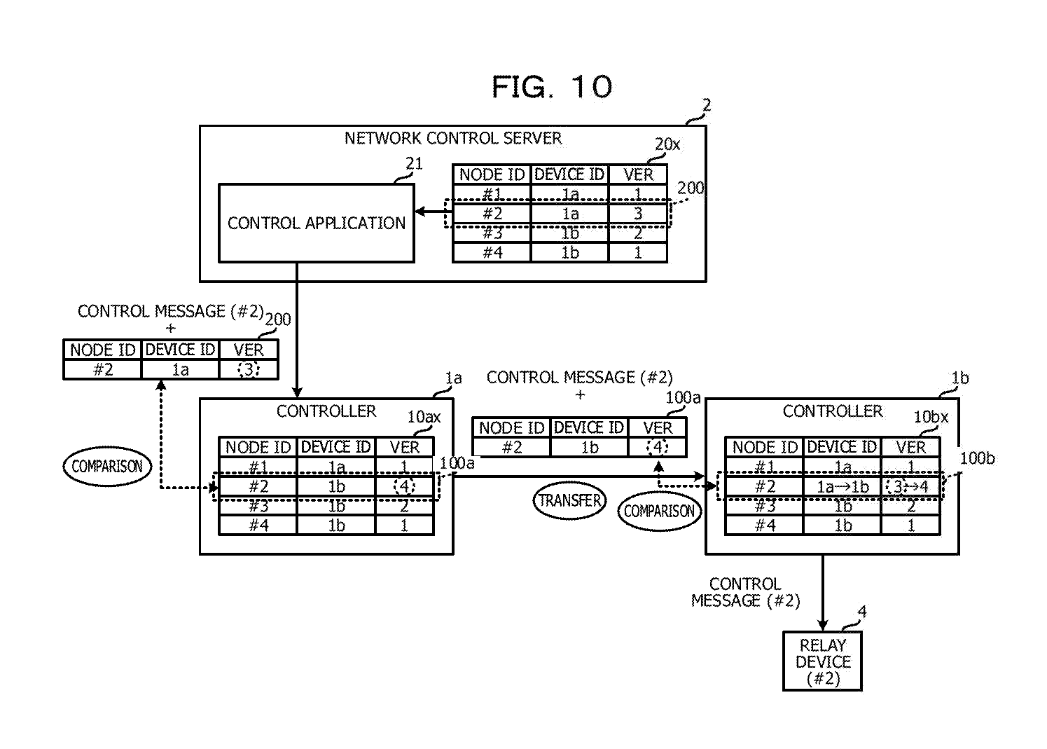

In FIG. 10, an operation of a second embodiment of a network system is illustrated. In FIG. 10, a configuration common to FIG. 1 is given the same symbol and description thereof is omitted. In the present embodiment, information relating to the numbers of times of update of pieces of controller information 20x, 10ax, and 10bx is used as the above-described comparison information.

For example, version information “VER” is used as the above-described information. The VER is stored for each of the nodes #1 to #4 in the pieces of controller information 20x, 10ax, and 10bx. The VER in the pieces of controller information 10ax and 10bx is one example of first update information and fourth update information. The VER in the controller information 20x is one example of second update information and third update information.

The VER is included in the instruction information 330 of the update instruction from the load control server 3. The VER is a numerical value that increases by one every update as one example. When the VER is larger, the information corresponding to this VER is newer. If the number of load control servers 3 is one as in the present embodiment, a counter may be provided in the update instructing unit 301 of the load control server 3 and the VER may be generated by the counter.

On the other hand, if plural load control servers 3 exist, a consensus algorithm like “RAFT” (refer to Diego Ongaro and John Ousterhout, “In Search of an Understandable Consensus Algorithm”) can be used for example in order to ensure the uniqueness of the VER. When receiving an update instruction, the update processing units 250 and 160 rewrite the VER of the relevant node ID in the pieces of controller information 20x, 10ax, and 10bx in accordance with the VER in the instruction information 330.

The control application 21 generates a control message addressed to the relay device 4 of the control target node #2 and then gives registration information 200 about the control target node #2 in the controller information 20x to the control message. In the registration information 200, the node ID “#2,” the device ID “1a,” and the VER “3” are included. The node ID and the device ID in the pieces of controller information 20x, 10ax, and 10bx in the present example are the same as those in the example of FIG. 8.

The control application 21 transmits the control message given the registration information 200 to the controller 1a. For example, in FIG. 6, the update processing unit 250 causes the non-volatile memory 28 to store the VER on each node basis. The message transmitting unit 252 gives the registration information 200 of the VER of the control target node #1 to #4 to the control message and transmits the control message given the registration information 200 to the controller 1a.

As described later, it suffices that the controller 1a can compare the newness between the pieces of controller information 20x and 10ax. Because the node ID and the device ID of the registration information 200 are obvious, only the VER may be given to the control message. That is, it is obvious that the node ID is the node ID “#2” equivalent to the destination of the control message and the device ID is the device ID “1a” of the controller 1a itself that has received the control message.

When receiving the control message given the registration information 200, the controller 1a compares the device ID “1a” included in the registration information 200 and the device ID “1b” in registration information 100a corresponding to the node ID “#2” in the controller information 10ax. For the controller 1a, the respective device IDs discord with each other as the result of the comparison. Thus, the controller 1a compares the VER “3” of the registration information 200 (see dotted-line circle) and the VER “4” of the registration information 100a (see dotted-line circle) (see “comparison”). The controller 1a thereby determines which of the registration information 200 of the network control server 2 and the registration information 100a of the self-device is newer regarding the control target node #2.

In the present example, the VER “4” of the registration information 100a about the control target node #2 is larger than the VER “3” of the registration information 200 given to the control message. Thus, as the result of the comparison of the respective VERs, the controller 1a determines that the registration information 100a of the self-device is newer than the registration information 200 of the network control server 2.

Therefore, the controller 1a determines that the device that controls the control target node #2 is not the self-device, and transfers the control message to the other controller 1b in accordance with the device ID “1b” of the registration information 100a (see “transfer”). At this time, the controller 1a gives the registration information 100a to the control message.

In this manner, the controller 1a gives the registration information 100a of the self-device to the control message and transfers the control message if determining that the registration information 100a of the self-device is newer than the registration information 200 of the network control server 2 based on the result of the comparison of the respective VERs. Because the VER is included in the registration information 100a (see dotted-line circle), the controller 1b as the transmission destination can compare the newness between the pieces of controller information 10ax and 10bx regarding the control target node #2 based on the VER.

When receiving the control message given the registration information 100a, the controller 1b compares the device ID “1b” included in the registration information 100a and the device ID “1a” in registration information 100b corresponding to the node ID “#2” in the controller information 10bx. Because the respective device IDs discord with each other as the result of the comparison, the controller 1b compares the VER “4” of the registration information 100a (see dotted-line circle) and the VER “3” of the registration information 100b (see dotted-line circle) (see “comparison”). The controller 1b thereby determines which of the registration information 100a of the other controller 1a and the registration information 100b of the self-device is newer regarding the control target node #2.

In the present example, the VER “4” of the registration information 100a about the control target node #2 is larger than the VER “3” of the registration information 100b. Thus, as the result of the comparison of the respective VERs, the controller 1b determines that the registration information 100a of the other controller 1a is newer than the registration information 100b of the self-device, and changes the controller information 10bx based on the registration information 100a.

For example, the controller 1b changes the device ID to “1b” and changes the VER to “4” (see arrows) so that the registration information 100b in the controller information 10bx may correspond with the registration information 100a of the other controller 1a. This allows the controller 1b to set the controller information 10bx of the self-device to the latest updated state.

The controller 1b can determine that the device that controls the control target node #2 is the self-device based on the controller information 10bx. Thus, the controller 1b transfers the control message to the relay device 4 of the control target node #2. This allows the controller 1b to control the relay device 4 of the control target node #2.

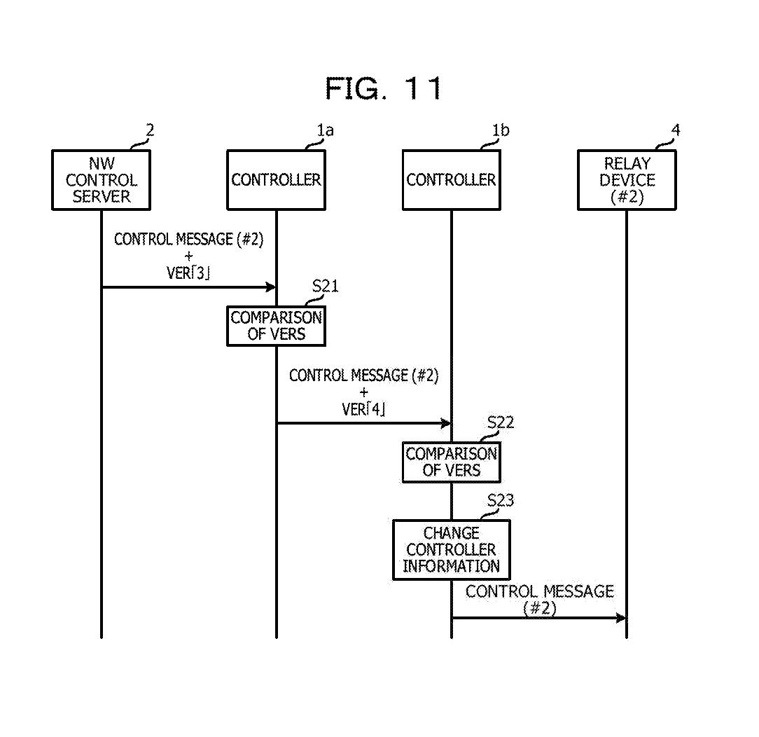

FIG. 11 is a sequence diagram illustrating an operation of the second embodiment of the network system. For example, FIG. 11 illustrates a sequence of the operation of FIG. 10.

First, the network control server 2 transmits the control message given the registration information 200 including the VER “3” to the controller 1a. Next, the controller 1a compares the VER “3” of the registration information 200 and the VER “4” of the registration information 100a in the controller information 10ax (see symbol S21).

The controller 1a determines that the registration information 100a of the self-device is newer than the registration information 200 of the network control server 2 as the result of the comparison of the respective VERs, and transmits the control message given the registration information 100a including the VER “4” to the controller 1b in accordance with the device ID “1b” of the registration information 100a. Next, the controller 1b compares the VER “4” of the registration information 100a and the VER “3” of the registration information 100b in the controller information 10bx (see symbol S22).

The controller 1b determines that the registration information 100a of the other controller 1a is newer than the registration information 100b of the self-device as the result of the comparison of the respective VERs, and changes the controller information 10bx based on the registration information 100a (see symbol S23). The controller information 10bx thereby becomes the latest updated state.

Next, the controller 1b transfers the control message to the relay device 4 of the control target node #2. In this manner, the network system operates.

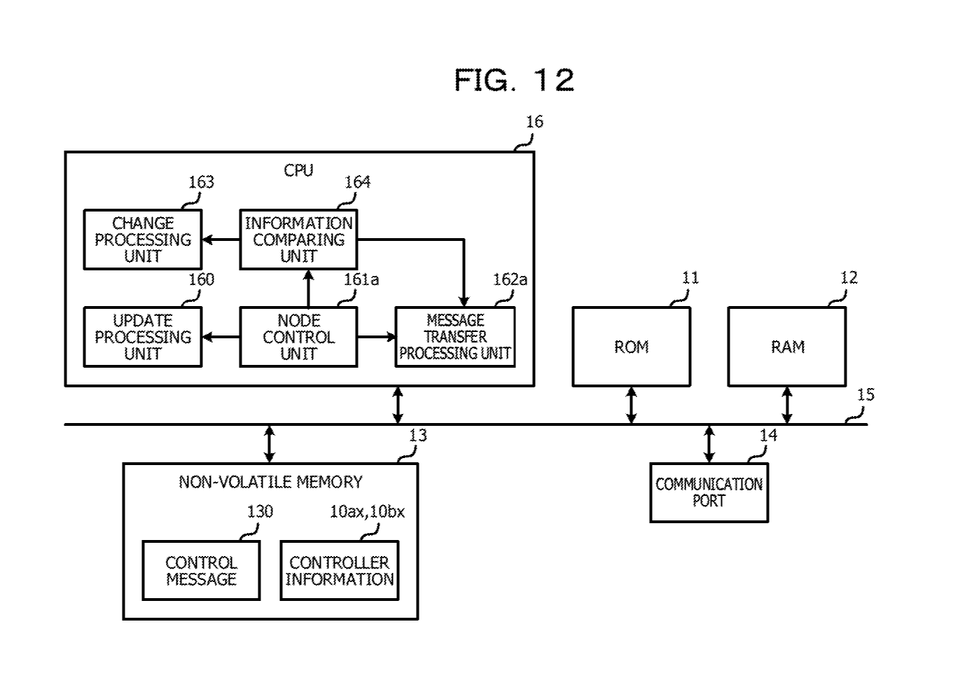

FIG. 12 is a configuration diagram illustrating the controllers 1a and 1b in the present embodiment. In FIG. 12, a configuration common to FIG. 7 is given the same symbol and description thereof is omitted.

The controllers 1a and 1b include the CPU 16, the ROM 11, the RAM 12, the non-volatile memory 13, and the communication port 14. When the CPU 16 reads a program from the ROM 11, the update processing unit 160, a node control unit 161a, a message transfer processing unit 162a, a change processing unit 163, and an information comparing unit 164 are formed as functions in the CPU 16.

The update processing unit 160 causes the non-volatile memory 13 to store the VER for each of the nodes #1 to #4 in accordance with an update instruction. Thus, the controller information 10ax or 10bx represented in FIG. 10 is held in the non-volatile memory 13.

The node control unit 161a is one example of the receiving unit. The node control unit 161a receives a control message given the registration information 200 or 100a via the communication port 14 and notifies the information comparing unit 164 of the VER in the registration information 200 or 100a.

The information comparing unit 164 is one example of a comparing unit and compares the VERs regarding the control target node. For example, the information comparing unit 164 compares the VER given to the received control message and the VER in the controller information 10ax or 10bx of the self-device. Then, the information comparing unit 164 notifies the change processing unit 163 and the message transfer processing unit 162a of the result of the comparison.

If it is determined that the registration information 200 or 100a given to the control message is newer than the registration information 100a or 100b of the self-device based on the result of the comparison of the respective VERs, the change processing unit 163 changes the registration information 100a or 100b of the self-device based on the registration information 200 or 100a given to the control message. This allows the controller 1a or 1b to set the controller information 10ax or 10bx of the self-device to the latest updated state.

The message transfer processing unit 162a is one example of the transfer processing unit. If it is determined that the registration information 100a or 100b of the self-device is newer than the registration information 200 or 100a given to the control message based on the result of the comparison of the respective VERs, the message transfer processing unit 162a gives the control message the registration information 100a or 100b about the control target node in the controller information 10ax or 10bx and transfers the control message. This allows the controller 1a or 1b as the transfer destination of the control message to compare the VERs.

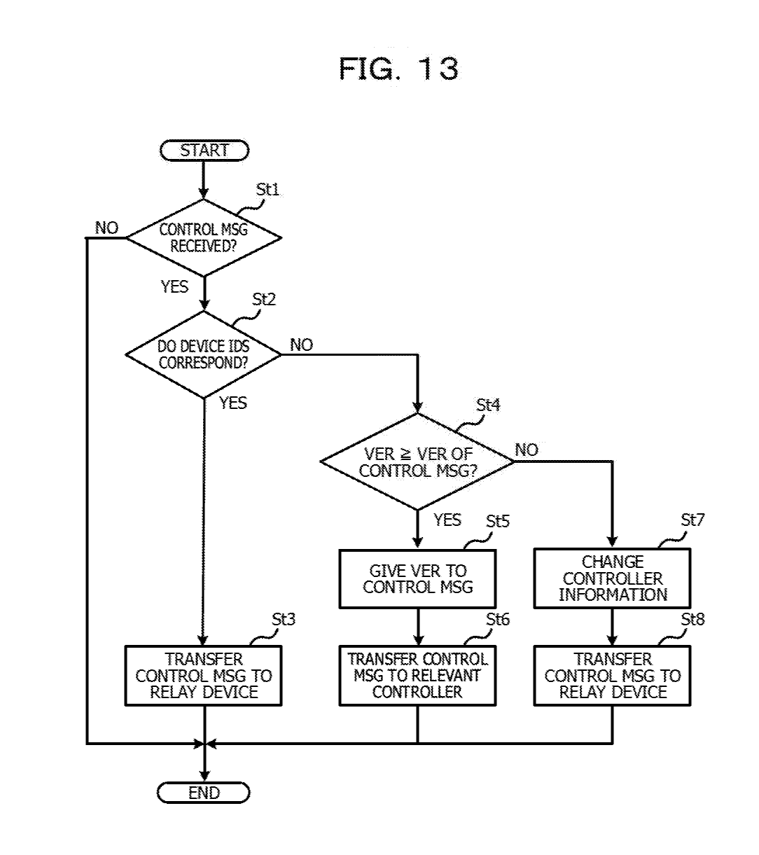

FIG. 13 is a flowchart illustrating an operation of the controller 1a or 1b in the second embodiment. The present operation is periodically carried out for example.

The node control unit 161a determines whether or not a control message (control MSG) has been received in the communication port 14 (SU). The controller 1a or 1b ends the operation if a control message has not been received (No of SU).

If a control message has been received (Yes of SU), the message transfer processing unit 162a detects the device ID corresponding to the node ID as the destination of the control message from the controller information 10ax or 10bx and compares this device ID with the device ID of the self-device (St2). If the respective device IDs correspond with each other (Yes of St2), the message transfer processing unit 162a determines that the device that controls the control target node #1 to #4 is the self-device, and transfers the control message to the relay device 4 of the control target node #1 to #4 (St3).

If the respective device IDs do not correspond with each other (No of St2), the information comparing unit 164 compares the VER of the registration information 200 or 100a given to the control message and the VER in the controller information 10ax or 10bx of the self-device (St4).

If the VER of the registration information 100a or 100b of the self-device is equal to or larger than the VER of the registration information 200 or 100a given to the control message (Yes of St4), the message transfer processing unit 162a gives the registration information 100a or 100b of the self-device to the control message (St5). Next, the message transfer processing unit 162a transfers the control message given the registration information 100a or 100b to the other controller 1a or 1b according to the device ID of the registration information 100a or 100b (St6).

If the VER of the registration information 100a or 100b of the self-device is smaller than the VER of the registration information 200 or 100a given to the control message (No of St4), the change processing unit 163 changes the registration information 100a or 100b of the self-device based on the registration information 200 or 100a given to the control message (St7). Even when the registration information 200 or 100a is not given to the control message, because the node ID and the device ID in the registration information 200 or 100a are obvious as described above, the change processing unit 163 can change the registration information 100a or 100b of the self-device from the obvious node ID and device ID.

Next, the message transfer processing unit 162a determines that the device that controls the control target node #1 to #4 is the self-device based on the registration information 100a or 100b, and transfers the control message to the control target node #1 to #4 (St8). In this manner, the controller 1a or 1b operates.

As above, according to the present embodiment, the newer controller information 10ax, 10bx, or 20x can be discriminated by the comparison of the VERs in the pieces of controller information 10ax, 10bx, and 20x. For this reason, the above-described ping-pong transmission of the control message is avoided. Accordingly, the delay of control processing of the relay device 4 is reduced.

### Third Embodiment

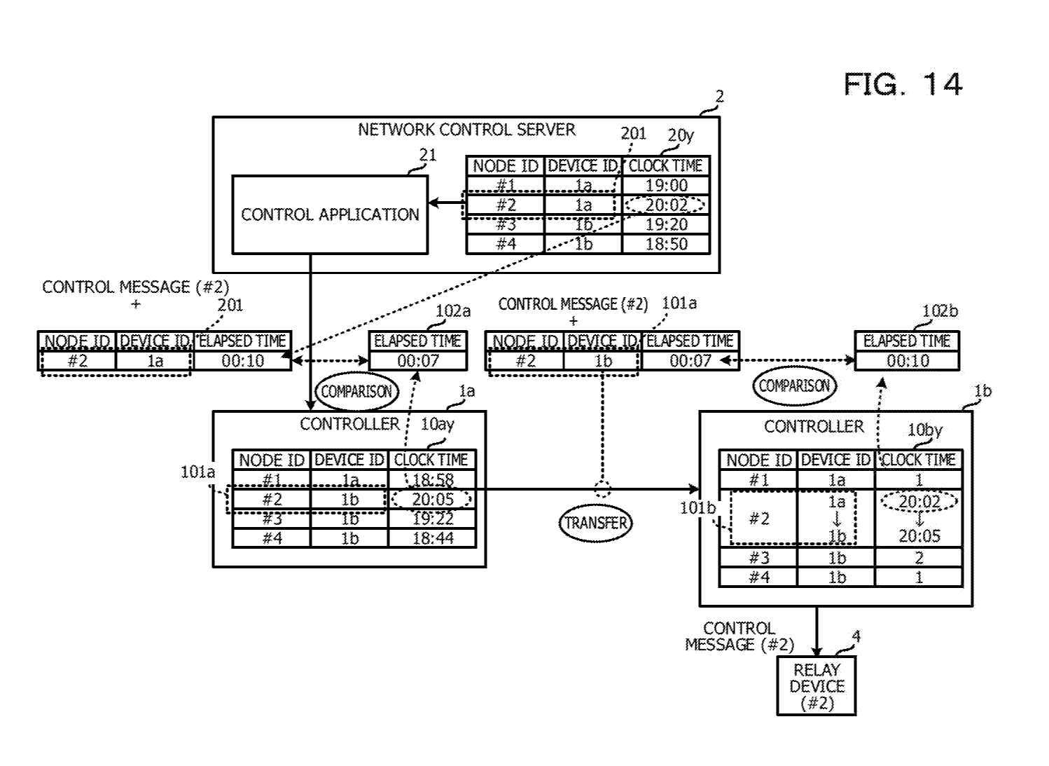

In FIG. 14, an operation of a third embodiment of a network system is illustrated. In FIG. 14, a configuration common to FIG. 1 is given the same symbol and description thereof is omitted. In the present embodiment, information relating to the clock times when pieces of controller information 20y, 10ay, and 10by are updated is used as the above-described comparison information.

For example, the elapsed times from the update clock times (elapsed time=current clock time−update clock time) regarding the pieces of controller information 20y, 10ay, and 10by are used as the above-described information. The update clock time is stored as update clock time information (see “clock time”) for each of the nodes in the pieces of controller information 20y, 10ay, and 10by. At the time of update of the pieces of controller information 20y, 10ay, and 10by based on an update instruction, the update processing units 250 and 160 each detect the update clock time by a timer for example. Then, the update processing units 250 and 160 update the update clock time information in the pieces of controller information 20y, 10ay, and 10by.

The network control server 2 and the controllers 1a and 1b give information indicating the elapsed time calculated from the update clock time of the controller information 20y, 10ay, or 10by (hereinafter, represented as the “elapsed time information”) to a control message and transmit the control message. The network control server 2 and the controllers 1a and 1b compare the newness among the pieces of controller information 20y, 10ay, and 10by by comparing the elapsed time information given to the control message and the elapsed time information obtained from the controller information 20y, 10ay, or 10by. Here, the update clock time information of the pieces of controller information 10ay and 10by is one example of first clock time information and fourth clock time information. The update clock time information of the controller information 20y is one example of second clock time information and third clock time information. A description will be made below by taking an operation example.

The control application 21 generates a control message addressed to the relay device 4 of the control target node #2 and then gives registration information 201 about the control target node #2 (node ID “#2” and device ID “ba”) and the elapsed time information “00:10” in the controller information 20y to the control message.

The elapsed time information is calculated from the update clock time information about the control target node #2 (clock time “20:02”) in the controller information 20y. In the present example, the current clock time is defined as “20:12” and the elapsed time “00:10” is calculated from the difference between the current clock time and the update clock time. The node ID and the device ID in the pieces of controller information 20y, 10ay, and 10by in the present example are the same as those in the example of FIG. 8.

The control application 21 transmits the control message given the registration information 201 and the elapsed time information to the controller 1a. For example, in FIG. 6, the update processing unit 250 causes the non-volatile memory 28 to store the update clock time information on each node basis. Then, the message transmitting unit 252 gives the registration information 201 and the elapsed time information to the control message and transmits the control message given the registration information 201 and the elapsed time information to the controller 1a. As described later, it suffices that the controller 1a can compare the newness between the pieces of controller information 20y and 10ay. Because the node ID and the device ID of the registration information 201 are obvious as described above, only the elapsed time information may be given to the control message.

When receiving the control message given the registration information 201 and the elapsed time information, the controller 1a compares the device ID “1a” included in the registration information 201 and the device ID “1b” in registration information 101a corresponding to the node ID “#2” in the controller information 10ay. Because the respective device IDs discord with each other as the result of the comparison, the controller 1a compares the elapsed time information “00:10” of the registration information 201 and the elapsed time information “00:07” (see symbol 102a) calculated from the update clock time information corresponding to the node ID “#2” (see dotted-line circle) (see “comparison”).

The controller 1a thereby determines which of the registration information 201 of the network control server 2 and the registration information 101a of the self-device is newer regarding the control target node #2. The time of the elapsed time information 102a is calculated from the difference between the current clock time “20:12” and the update clock time “20:05.”

In the present example, the time “00:07” of the elapsed time information of the registration information 101a about the control target node #2 is smaller than the time “00:10” of the elapsed time information given to the control message. Thus, the controller 1a determines that the registration information 101a of the self-device is newer than the registration information 201 of the network control server 2 as the result of the comparison of the respective pieces of elapsed time information.

Accordingly, the controller 1a determines that the device that controls the control target node #2 is not the self-device, and transfers the control message to the other controller 1b in accordance with the device ID “1b” of the registration information 101a (see “transfer”). At this time, the controller 1a gives the registration information 101a and the elapsed time information “00:07” to the control message.

As above, if determining that the registration information 101a of the self-device is newer than the registration information 201 of the network control server 2 based on the result of the comparison of the respective pieces of elapsed time information, i.e. the pieces of update clock time information, the controller 1a gives the registration information 101a of the self-device and the elapsed time information to the control message and transfers the control message. This allows the controller 1b as the transfer destination to compare the newness between the pieces of controller information 10ay and 10by regarding the control target node #2 based on the elapsed time information.

When receiving the control message given the registration information 101a and the elapsed time information, the controller 1b compares the device ID “1b” included in the registration information 101a and the device ID “1a” in registration information 101b corresponding to the node ID “#2” in the controller information 10by. For the controller 1b, the respective device IDs discord with each other as the result of the comparison. Thus, the controller 1b compares the elapsed time information “00:07” given to the control message and the elapsed time information “00:10” (see symbol 102b) calculated from the update clock time information corresponding to the node ID “#2” (see dotted-line circle) (see “comparison”). The controller 1b thereby determines which of the registration information 101a of the other controller 1a and the registration information 101b of the self-device is newer regarding the control target node #2.

In the present example, the time “00:10” of the elapsed time information of the registration information 101b of the controller 1b is larger than the time “00:07” of the elapsed time information given to the control message. Thus, the controller 1b determines that the registration information 101a of the other controller 1a is newer than the registration information 101b of the self-device as the result of the comparison of the respective pieces of elapsed time information, and changes the controller information 10by based on the registration information 101a.

For example, the controller 1b changes the device ID to “1b” so that the registration information 101b in the controller information 10by may correspond with the registration information 101a of the other controller 1a. Furthermore, the controller 1b changes the update clock time information to “20:05” (see arrow) based on the received elapsed time information. This allows the controller 1b to set the controller information 10by of the self-device to the latest updated state.

In the present embodiment, the controllers 1a and 1b compare the newness among the pieces of controller information 20y, 10ay, and 10by by comparing the elapsed time information. However, the configuration is not limited thereto. For example, if the clock time synchronization of the timer that counts the current clock time is established among the network control server 2 and the respective controllers 1a and 1b, the controllers 1a and 1b may compare the update clock time information instead of the elapsed time information.

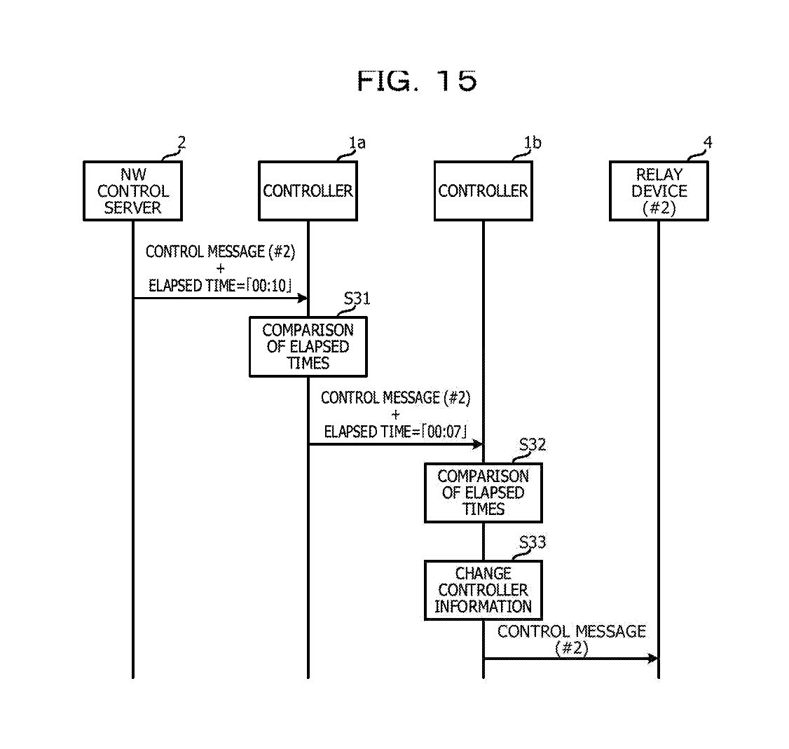

FIG. 15 is a sequence diagram illustrating an operation of the third embodiment of the network system. For example, FIG. 15 illustrates a sequence of the operation of FIG. 14.

First, the network control server 2 transmits the control message given the registration information 201 and the elapsed time information “00:10” to the controller 1a. Next, the controller 1a compares the elapsed time information “00:10” and the elapsed time information “00:07” calculated from the update clock time information in the controller information 10ay (see symbol S31).

The controller 1a determines that the registration information 101a of the self-device is newer than the registration information 201 of the network control server 2 as the result of the comparison of the respective pieces of elapsed time information. Then, the controller 1a transmits the control message given the registration information 101a and the elapsed time information “00:07” to the controller 1b in accordance with the device ID “1b” of the registration information 101a. Next, the controller 1b compares the elapsed time information “00:07” of the registration information 101a and the elapsed time information “00:10” in the controller information 10by (see symbol S32).

The controller 1b determines that the registration information 101a of the other controller 1a is newer than the registration information 101b of the self-device as the result of the comparison of the respective pieces of elapsed time information. Then, the controller 1b changes the controller information 10by based on the elapsed time information given to the control message (see symbol S33). The controller information 10by thereby becomes the latest updated state.

Next, the controller 1b transfers the control message to the relay device 4 of the control target node #2. In this manner, the network system operates.

The controllers 1a and 1b in the present embodiment have the same configuration as the above-described configuration of FIG. 12. When the pieces of controller information 10ay and 10by are updated in accordance with an update instruction, the update processing unit 160 acquires the current clock time from an internal timer for example and causes the non-volatile memory 13 to store the current clock time as the update clock time information for each of the nodes #1 to #4. Thus, the controller information 10ay or 10by represented in FIG. 14 is held in the non-volatile memory 13.

The node control unit 161a is one example of the receiving unit. The node control unit 161a receives the control message given the registration information 201 or 101a and the elapsed time information via the communication port 14 and notifies the information comparing unit 164 of the elapsed time information.

The information comparing unit 164 is one example of the comparing unit. The information comparing unit 164 compares the elapsed time information given to the control message and the update clock time information of the self-device, i.e. the elapsed time information calculated from the update clock time information, regarding the control target node. The information comparing unit 164 notifies the change processing unit 163 and the message transfer processing unit 162a of the result of the comparison of the respective pieces of elapsed time information.

If it is determined that the registration information 201 or 101a given to the control message is newer than the registration information 101a or 101b of the self-device based on the result of the comparison of the respective pieces of elapsed time information, the change processing unit 163 changes the registration information 101a or 101b of the self-device based on the registration information 201 or 101a given to the control message. Moreover, the change processing unit 163 changes the update clock time information of the controller information 10ay or 10by of the self-device based on the elapsed time information given to the control message. This allows the controller 1a or 1b to set the controller information 10ay or 10by of the self-device to the latest updated state.

The message transfer processing unit 162a is one example of the transfer processing unit. If it is determined that the registration information 101a or 101b of the self-device is newer than the registration information 201 or 101a given to the control message based on the result of the comparison of the respective pieces of elapsed time information, the message transfer processing unit 162a gives the control message the registration information 101a or 101b about the control target node in the controller information 10ay or 10by and transfers the control message. This allows the controller 1a or 1b as the transfer destination of the control message to compare the elapsed time information.

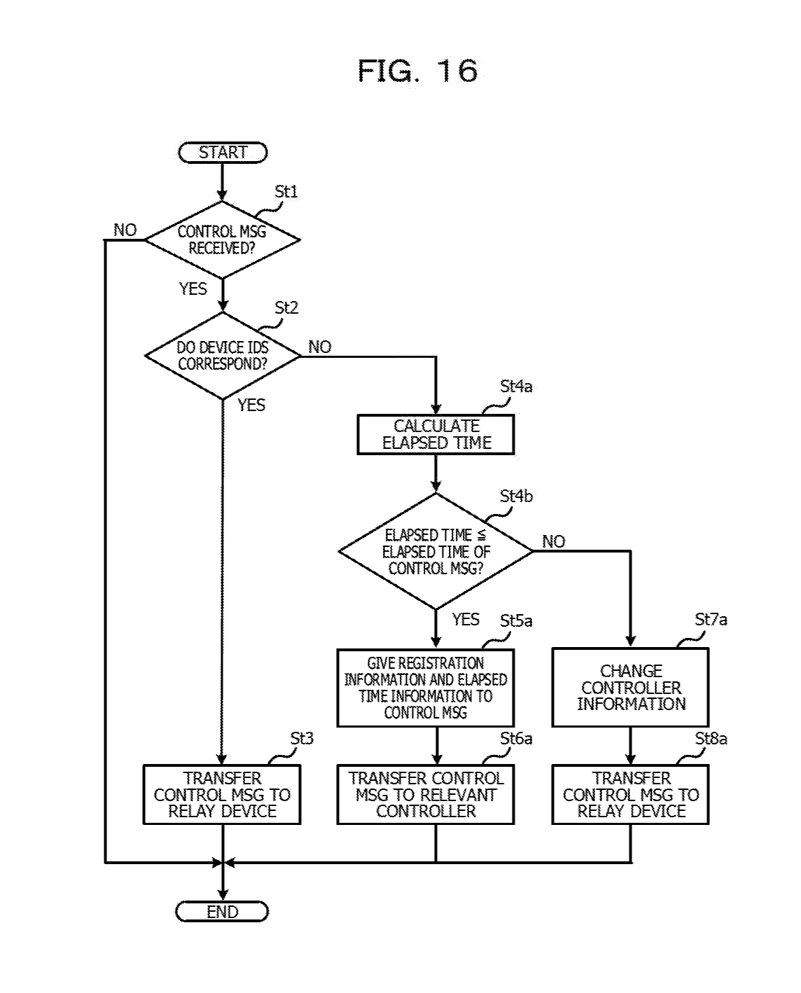

FIG. 16 is a flowchart illustrating an operation of the controller 1a or 1b in the third embodiment. In FIG. 16, processing common to FIG. 13 is given the same symbol and description thereof is omitted. The present operation is periodically carried out for example.

If the respective device IDs do not correspond with each other (No of St2), the information comparing unit 164 calculates the elapsed time from the clock time of the update clock time information in the controller information 10ay or 10by (St4a). The information comparing unit 164 thereby acquires the elapsed time information. Next, the information comparing unit 164 compares the elapsed time information given to the control message and the elapsed time information of the self-device acquired from the update clock time information (St4b).

If the time of the elapsed time information of the self-device is equal to or smaller than the time of the elapsed time information given to the control message (Yes of St4b), the message transfer processing unit 162a gives the registration information 101a or 101b of the self-device and the elapsed time information to the control message (St5a). Next, the message transfer processing unit 162a transfers the control message given the registration information 101a or 101b and the elapsed time information to the other controller 1a or 1b according to the device ID of the registration information 101a or 101b (St6a).

If the time of the elapsed time information of the self-device is larger than the time of the elapsed time information given to the control message (No of St4b), the change processing unit 163 changes the registration information 101a or 101b of the self-device based on the registration information 201 or 101a given to the control message (St7a). Even when the registration information 201 or 101a is not given to the control message, the node ID and the device ID in the registration information 201 or 101a are obvious as described above. For this reason, the change processing unit 163 can change the registration information 101a or 101b of the self-device from the obvious node ID and device ID.

Next, the message transfer processing unit 162a determines that the device that controls the control target node #1 to #4 is the self-device based on the registration information 101a or 101b. Then, the message transfer processing unit 162a transfers the control message to the control target node #1 to #4 (St8a). In this manner, the controller 1a or 1b operates.

As above, according to the present embodiment, the newer controller information 10ay, 10by, or 20y can be discriminated by the comparison of the elapsed time information in the pieces of controller information 10ay, 10by, and 20y. Thus, the above-described ping-pong transmission of the control message is avoided. Accordingly, the delay of control processing of the relay device 4 is reduced.

As described thus far, the controllers 1a and 1b according to the embodiments exist in the network NW2 for control including the plural nodes #1 to #4 and the controllers 1a and 1b that control the plural nodes #1 to #4. The controllers 1a and 1b include the non-volatile memory 13, the update processing unit 160, the node control unit 161 or 161a, and the message transfer processing unit 162 or 162a. The non-volatile memory 13 stores the controller information 10a, 10ax, 10ay, 10b, 10bx, or 10by indicating the correspondence relationship between the respective nodes #1 to #4 and the controllers 1a and 1b that control the respective nodes #1 to #4.

The update processing unit 160 updates the controller information 10a, 10ax, 10ay, 10b, 10bx, or 10by in accordance with an update instruction of the load control server 3. The node control units 161 and 161a receive a control message for the control target node #1 to #4 from the network control server 2.

When the controller 1a or 1b associated with the control target node #1 to #4 in the controller information 10a, 10ax, 10ay, 10b, 10bx, or 10by is not the self-device, the message transfer processing units 162 and 162a transfer the control message to the other controller 1a or 1b associated with the control target node #1 to #4.

According to the above-described configuration, when the controller 1a or 1b that controls the control target node is not the self-device, the message transfer processing units 162 and 162a transfer the control message to the other controller 1a or 1b that controls the control target node. Thus, the control message is not discarded and therefore the network control server 2 does not need to retransmit the control message. Accordingly, according to the controllers 1a and 1b in accordance with the embodiments, the delay time of the control of the control target node #1 to #4 is reduced.

The network system according to the embodiments includes the plural nodes #1 to #4, the network control server 2, the controllers 1a and 1b, and the load control server 3. The network control server 2 generates control messages for the respective nodes #1 to #4. The controllers 1a and 1b control the plural nodes #1 to #4.

The network control server 2 includes the non-volatile memory 28, the update processing unit 250, and the message transmitting unit 252. The non-volatile memory 28 stores the controller information 20, 20x, or 20y indicating the correspondence relationship between the respective nodes #1 to #4 and the controllers 1a and 1b that control the respective nodes #1 to #4. The update processing unit 250 updates the controller information 20, 20x, or 20y in accordance with an update instruction of the load control server 3. The message transmitting unit 252 transmits a control message to the controller 1a or 1b associated with the control target node #1 to #4 in the controller information 20, 20x, or 20y.

The controllers 1a and 1b include the non-volatile memory 13, the update processing unit 160, the node control unit 161 or 161a, and the message transfer processing unit 162 or 162a. The non-volatile memory 13 stores the controller information 10a, 10ax, 10ay, 10b, 10bx, or 10by indicating the correspondence relationship between the respective nodes #1 to #4 and the controllers 1a and 1b that control the respective nodes #1 to #4.

The update processing unit 160 updates the controller information 10a, 10ax, 10ay, 10b, 10bx, or 10by in accordance with an update instruction of the load control server 3. The node control units 161 and 161a receive the control message transmitted from the message transmitting unit 252.

When the controller 1a or 1b associated with the control target node #1 to #4 in the controller information 10a, 10ax, 10ay, 10b, 10bx, or 10by is not the self-device, the message transfer processing units 162 and 162a transfer the control message to the other controller 1a or 1b associated with the control target node #1 to #4.

The load control server 3 instructs the network control server 2 and the controllers 1a and 1b to update the pieces of controller information 20, 20x, or 20y, and 10a, 10ax, or 10ay, and 10b, 10bx, or 10by, respectively.

The network system according to the embodiments includes the same configuration as the above-described controllers 1a and 1b and therefore provides the same operation and effects as the above-described contents.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A communication control method executed by a system, the communication control method comprising:
transmitting, by a load control device, a request instructing update of destination information to a plurality of communication control devices that control a plurality of nodes and a network control device that controls the plurality of communication control devices, the destination information being stored in each of the plurality of communication control devices and the network control device and including a correspondence relationship between a node and a communication control device that control the node for each of the plurality of nodes;
starting, by each of the plurality of communication control devices and the network control device, update of the destination information in response to the request;
completing the update by a communication control device among the plurality of communication control devices;
receiving, by the communication control device, a control message that is transmitted from the network control device and is for controlling a target node in the plurality of nodes;
extracting a target control device that controls the target node from the plurality of communication control devices stored in the destination information of the communication control device in response to the control message; and
transferring the control message from the communication control device to the target control device when it is determined that the extracted target control device is not the communication control device.

2. The communication control method according to claim 1,
wherein the request is a request for changing a control device that controls the target node from the communication control device to the target control device.

3. The communication control method according to claim 2, further comprising:
receiving, by the network control device, the request from the load control device;
extracting the communication control device corresponding to the target node from the plurality of communication control devices stored in the destination information of the network control device before completion of update of the destination information carried out in response to the request; and
transmitting the control message to the extracted communication control device.

4. The communication control method according to claim 1, further comprising
receiving, by the target control device, the control message transferred by the communication control device after completion of update of the destination information carried out in response to the request.

5. The communication control method according to claim 1, further comprising:
storing, by the communication control device, first update information indicating a number of times of update of the destination information of the communication control device regarding each of the plurality of nodes;
adding, by the network control device, second update information to the control message, the second update information indicating the number of times of update of the destination information relating to the target node in the network control device in accordance with an instruction from the load control device; and
changing, by the communication control device, the destination information of the communication control device based on the destination information of the network control device when it is determined that the destination information of the network control device is newer than the destination information of the communication control device based on comparison between the first update information and the second update information.

6. The communication control method according to claim 5, further comprising
adding, by the communication control device, the first update information to the control message regarding the target node and transferring the control message to the target control device when determining that the destination information of the communication control device is newer than the destination information of the network control device based on the comparison.

7. The communication control method according to claim 1, further comprising:
storing, by the communication control device, first clock time information indicating a clock time when the destination information of the communication control device is updated regarding each of the plurality of nodes;
adding, by the network control device, second clock time information to the control message, the second clock time information indicating a clock time when the destination information relating to the target node in the network control device is updated in accordance with an instruction from the load control device;
comparing the first clock time information and the second clock time information regarding the target node; and
changing, by the communication control device, the destination information of the communication control device based on the destination information of the network control device when it is determined that the destination information of the network control device is newer than the destination information of the communication control device based on the comparison between the first clock time information and the second clock time information.

8. The communication control method according to claim 7, further comprising
adding, by the communication control device, the first clock time information to the control message regarding the target node and transferring the control message to the target control device when it is determined that the destination information of the communication control device is newer than the destination information of the network control device based on the comparison.

9. A network system, comprising:
a plurality of nodes;
a plurality of communication control devices configured to control the plurality of nodes;
a network control device configured to control the plurality of communication control devices; and
a load control device configured to control a load of the plurality of communication control devices relating to the plurality of nodes, wherein
each of the plurality of communication control devices and the network control device includes destination information including a correspondence relationship between a node and a communication control device that control the node for each of the plurality of nodes, and
the load control device is configured to
transmit a request instructing update of the destination information to the plurality of communication control devices and the network control device, and
each of the plurality of communication control devices and the network control device is configured to
start update of the destination information in response to the request, and
a communication control device in the plurality of communication control devices is configured to:
complete the update of the destination information;
receive a control message that is transmitted from the network control device and is for controlling a target node in the plurality of nodes;
extract a target control device that controls the target node from the plurality of communication control devices stored in the destination information of the communication control device in response to the control message; and
transfer the control message to the target control device when it is determined that the extracted target control device is not the communication control device.

10. A communication control device comprising:
a memory; and
a processor coupled to the memory and configured to:
update destination information in response to a request instructing update of the destination information that is transmitted from a load control device to a plurality of communication control devices that control a plurality of nodes and a network control device that controls the plurality of communication control devices, the destination information being stored in each of the plurality of communication control devices and the network control device and including a correspondence relationship between a node and a communication control device that control the node for each of the plurality of nodes;
receive a control message that is transmitted from the network control device and is for controlling a target node in the plurality of nodes;
extract a target control device that controls the target node from the plurality of communication control devices stored in the destination information of the communication control device in response to the control message; and
transfer the control message to the target control device when it is determined that the extracted target control device is not the communication control device.
